(19) United States
(12) Patent Application Publication
(10) Pub. No.: US 2005/0064081 A1
(43) Pub. Date: Mar. 24, 2005

(54) Food product and method

(75) Inventor: Robert A. Skaletski, Green Bay, WI (US)

Correspondence Address: WILHELM LAW SERVICE, S.C., 100 W LAWRENCE ST, THIRD FLOOR, APPLETON, WI, 54911, US

(73) Assignee: RapidX Technologies Inc., Ripon, WI (US)

(21) Appl. No.: 10/946,522

(22) Filed: Sep. 20, 2004

Related U.S. Application Data
(60) Provisional application No. 60/503,716, filed on Sep. 19, 2003.

(51) Int. Cl. A23C 19/00

(52) U.S. Cl. 426/582

(57) ABSTRACT

This invention pertains to cheese and certain meat products which are molded in a wide variety of novel three-dimensional shapes and sizes which deviate from the common rectangular blocks, balls, and the like, and which have not previously been available. Such shapes can be made by pressure molding a wide range of varieties of cheese and certain flowable meat products which are commonly fabricated, such as into sausages. Such shapes can also be made by injection molding processes. The invention comprises the new shapes of products now available, which can be fabricated from cheese, and certain meat products. The invention further comprehends pressure molding processes and injection molding processes for making such shaped products.

### BACKGROUND

This invention relates to food products, and methods of making, packaging, and distributing such food products. While the invention relates to a variety of food products, the invention is described herein in detail with respect to products comprising cheese and products derived from cheese. It is also contemplated that at least some of the products and methods described herein can be implemented with certain kinds of fabricated meat products.

As used herein, except where specifically indicated otherwise, “cheese” refers to all forms of cheese and cheese derivatives, such as for example and without limitation, cheese, pasteurized process cheese, pasteurized cheese, pasteurized process American cheese, pasteurized process cheese food, pasteurized process cheese spread, pasteurized process cheese product, and imitation cheese.

Where the phrases “cheese product” or “cheese” are used herein without further specifically-recited limitation, such wording refers to the full range of cheese-related foods, and not specifically to “pasteurized process cheese product”.

Further in regard to the types of food products addressed here, a wide range of cheese varieties is included. Indeed, any cheese which can be made to meet the shape parameters described herein can be employed in the invention. Thus, there can be mentioned as cheese varieties, for example and without limitation, the more common cheeses such as cheddar cheese, colby cheese, mozzarella cheese, provolone cheese, American cheese and swiss cheese, including variations of cheese which contain inclusions such as peppers and/or other vegetables, spices, meat particles, and the like.

This invention relates specifically to the shape of the cheese product, which is shipped into commerce, typically for direct use by a consumer of such cheese product, or in the catering or food service industries. Accordingly, the invention relates to the product itself, to packages of such cheese product, to methods of making cheese into product units of various novel shapes, and to methods of making packages of cheese wherein the contained cheese products embody such novel product shapes.

### SUMMARY

Described in the invention are cheese and certain meat products that are molded in a wide variety of novel three-dimensional shapes and sizes which deviate from the common rectangular blocks, balls, and the like, and which have not previously been available. Such shapes can be made by pressure molding a wide range of cheese varieties and certain flowable meats products, which are commonly fabricated such as in sausages. Such shapes can also be made by injection molding processes. The invention comprises the new shapes of products now available as a result of the invention, which can be fabricated from cheese, and certain meat products. The invention further comprehends pressure molding processes and injection molding processes for making such shaped products.

In a first set of embodiments, the invention comprehends a cheese product comprising a mass of cheese having a plurality of outer surface elements which collectively define an outer surface of the cheese product. The cheese product has a length and a width. The length is greater than the width. First and second ends of the product are defined by converging ones of the outer surface elements. A longitudinal axis extends between the first and second ends. The cheese product is substantially free from any substantially flat outer surface elements of the cheese product, proximate either of the first and second ends and extending across the longitudinal axis.

In some embodiments, one or more flat ones of the outer surface elements collectively represent from zero up to no more than about 5 percent of the outer surface of the cheese product.

In some embodiments, the cheese product further comprises a relatively greater-diameter medial portion, and first and second tapered end portions terminating in the first and second ends.

In some embodiments, the cheese product further comprises a relatively planar surface generally aligned with the longitudinal axis and disposed in the medial portion.

In some embodiments, the length is generally aligned with the longitudinal axis, the relatively planar surface having a second length, substantially shorter than the first length.

In some embodiments, the cheese product comprises a main body, and further comprises one or more relatively thin outer layers of cheese overlying the outer surface of the main body, and collectively covering no more than about 20 percent of the main body.

In some embodiments, the cheese product comprises a main body, and further comprises one or more relatively thin outer layers of a meat product overlying the outer surface of the main body, and collectively covering no more than about 20 percent of the main body.

In some embodiments, the cheese product is contained in a package, defined by packaging structure, the packaging structure comprising one or more finishing mold elements effective to fabricate the cheese product into a finished shape and size upon evacuation of air from the package and application of ambient air pressure to an outside surface of the package.

In some embodiments, one of the finishing mold elements comprises a plunger which extends into another of the finishing mold elements.

In some embodiments, the packaged cheese product further comprises a bag, overlying the finishing mold elements, and providing an outer enclosing structure of the package.

In a second family of embodiments, the invention comprehends a cheese product having a generally non-globoidal shape and comprising a mass of cheese. The cheese product is substantially free from any flat element of the outer surface of such cheese product, which defines more than about 5 percent of the outer surface.

In some embodiments, the cheese product is substantially free from flat elements of the outer surface which collectively define more than about 5 percent of the outer surface.

In a third family of embodiments, the invention comprehends a cheese product comprising a mass of cheese having a plurality of separately distinguishable outer surface elements which collectively define an outer surface of the cheese product, one or more of the outer surface elements which define at least 5 percent of the collective outer surface and being substantially lofted, or being substantially concave and non-spherical in primary outline.

In some embodiments, the cheese product further comprises first and second ends, and a longitudinal axis extending between the first and second ends, and a generally planar surface generally aligned with the longitudinal axis.

In a fourth family of embodiments, the invention comprehends a cheese product comprising a mass of cheese having one or more separately distinguishable outer surface elements which collectively define an outer surface of the cheese product. At least 50 percent of the outer surface of the cheese product is defined by one or more non-globoidal substantially lofted and/or non-globoidal substantially depressed portions of the outer surface, and wherein such substantial loftings and/or substantial depressions in such lofted and/or depressed portions represent at least about 25 percent of the lofted and/or depressed portions.

In a fifth family of embodiments, the invention comprehends a cheese product comprising a mass of cheese having a plurality of outer surface features which collectively define an outer surface of the cheese product, one or more of the outer surface features being characterized by one or more of lofted portions which are non-globoidal in primary outline, and/or one or more of concave portions which are non-spherical in primary outline.

In some embodiments, the cheese product has first and second ends, and a plurality of the lofted and/or concave portions extend along the length of the cheese product.

In some embodiments, the cheese product has first and second ends, a plurality of the lofted and/or concave portions extending along the length of the cheese product and having length to width ratios, the width being measured perpendicular to the horizontal axis, of at least about 3/1, optionally at least about 5/1, up to at least 10/1 or more. Such lofted and/or concave portions, such as ridges and/or folds, can extend substantially greater than 50 percent, up to 100 percent, of the length of the cheese product.

In a sixth family of embodiments, the invention comprehends a cheese product comprising a mass of cheese having a plurality of outer surface features which collectively define an outer surface of the cheese product, the cheese product comprising a main body, and one or more of the outer surface features comprising an appendage extending from the main body.

In some embodiments, the main body comprises a first major body, and further comprising a second major body, connected to the first major body by the appendage, whereby the appendage comprises an isthmus between the first and second main bodies, the isthmus having “X” and “Y” dimensions, transverse to an imaginary line extending through the isthmus and into the first and second major bodies, less than corresponding “X” and “Y” dimensions of the first and second major bodies as measured from the same imaginary line.

In a seventh family of embodiments, the invention comprehends a cheese product comprising a mass of cheese, an outer surface of the cheese product having a plurality of separately distinguishable surface variation elements disposed about more than a 180 degree portion of the outer surface, e.g. about 270 degrees, or about 360 degrees, of the outer surface perimeter, the surface variation elements comprising lofted projections visible with a naked eye in primary outline, and/or substantially concave elements visible with the naked eye and which are non-spherical in primary outline.

In some embodiments, the surface variation elements collectively extend substantially about the cheese product.

In some embodiments, the surface variation elements collectively extend substantially about the cheese product, and the portion of the surface area of the cheese product which is covered by surface variation elements, and spaces between closely adjacent ones of the surface variation elements, represents at least 50 percent of the entirety of the surface area of the cheese product.

In an eighth family of embodiments, the invention comprehends a cheese product comprising a mass of cheese, and comprising a first inner mass of a first food product defined in terms of first visual or tactile or taste sensibility; and a second outer mass of a second food product, disposed outwardly of the first inner mass of the first food product. The second food product is defined in terms of second visual or tactile or taste sensibility, substantially different from at least one of the first visual or tactile or taste sensibility of the first food product, and wherein at least one of the first and second food products comprises, in substantial portion, a cheese product.

In some embodiments, the second outer mass of the second food product comprises a cheese product and entirely encompasses the first inner mass of the first food product.

In some embodiments, the first food product comprises a first cheese product and wherein the second food product comprises a second cheese product, and wherein the first cheese product differs from the second cheese product in taste.

In some embodiments, the first food product comprises a first cheese product and wherein the second food product comprises a second cheese product, and wherein the first cheese product differs from the second cheese product in visual sensibility.

In some embodiments, the first food product comprises a first cheese product and wherein the second food product comprises a second cheese product, and wherein the first cheese product differs from the second cheese product according to color.

In some embodiments, the first food product comprises a first cheese product and wherein the second food product comprises a second cheese product, and wherein the first cheese product differs from the second cheese product according to texture.

In a ninth family of embodiments, the invention comprehends a method of making a cheese product into a desired finished shape and size after forming cheese curd. The method comprises providing a portion of such cheese curd, or a subsequently developed product derived from such cheese curd, in working relationship with one or more pre-form molds, which pre-form molds generally reflect the desired finished shape and size of the desired cheese product in gross outline; applying pressure to the molds e.g. along one, two, or three mutually perpendicular axes, and through the molds to the block of cheese while the block of cheese is at a temperature substantially below the melting temperature of the cheese, thereby to cold-form the cheese into a cheese pre-form which generally reflects the desired finished shape and size of the cheese product, and which contains a mass of cheese closely corresponding to the desired finished shape and size of the cheese product; placing the cheese pre-form in molding relationship to at least first and second finishing mold elements which collectively have an interior surface which closely reflects the desired finished shape and size of the cheese product, the finishing mold elements defining packaging material; closing off the combination of the cheese pre-form and the finishing mold elements from ambient air pressure, and while so closed off, evacuating air from the combination of the cheese pre-form and the mold elements, and using the finishing mold elements as at least part of a packaging structure to separate the cheese pre-form from ambient air, and sealing the packaging structure thereby to provide a closed and sealed package; subjecting an outer surface of the package to gaseous pressure which causes the packaging material to exert pressure on the contained cheese pre-form, sufficient to cause the cheese in the pre-form to flow, relative to the finishing mold elements, and along and into respective contours at the inner surfaces of the mold elements, whereby the finished shape of the so-formed cheese product closely reflects the interior surfaces of the finishing mold elements while the interior surfaces of the mold elements substantially retain their shapes.

In some embodiments the method further comprises holding the cheese product in the closed and sealed package for a time necessary for the cheese product to substantially fully conform to the finishing mold elements, and to dissipate substantially all of any spring-back forces which may be extant in the cheese.

In some embodiments, the method further comprises holding the cheese product in the closed and sealed package for a time necessary for the cheese product to substantially fully re-knit together in the newly-established shape of the cheese product.

In some embodiments, the method further comprises providing a release sheet between the cheese and the finishing mold elements.

In some embodiments, the method further comprises pre-warming the cheese to a temperature no less than 30 degrees F. below the melting point of the cheese before forming the cheese pre-form.

In some embodiments, the method further comprises shipping the so-packaged cheese product into commerce while the cheese product is contained in a package comprising the finishing mold elements.

In some embodiments, material for the finishing mold elements is selected from the group consisting of polyethylenes, polypropylenes, polyethylene terephthalates, polyvinyl chlorides, and polyamides.

In some embodiments, the method further comprises, prior to subjecting the outer surface of the package to the gaseous pressure, overwrapping the combination of the cheese pre-form and the finishing mold elements in a bag, and subsequently performing the evacuating of air from the combination, and sealing the packaging structure, the sealing of the packaging structure comprising at least in part forming closure seal to thereby seal the bag.

In some embodiments, the portion of cheese curd or a subsequently developed product derived from such cheese curd comprises a consolidated block of cheese.

In some embodiments, the cheese is a ripened cheese. In other embodiments, the cheese is an unripened cheese

In a tenth family of embodiments, the invention comprehends a method of making a cheese product into a desired finished shape and size after forming cheese curd into a consolidated block of cheese. The method comprises comminuting the cheese thereby to form a mass of comminuted cheese particles; providing a portion of the mass of comminuted cheese in molding relationship to at least first and second finishing mold elements which collectively have an interior surface which closely reflects the desired finished shape and size of the cheese product to be fabricated, the finishing mold elements defining packaging material; closing off the combination of the portion of the mass of comminuted cheese, and the finishing mold elements, from ambient air pressure, and while so closed off, evacuating air from the combination of the cheese and the mold elements, and using the mold elements as at least part of a packaging structure to separate the cheese from ambient air, and sealing the packaging structure thereby to provide a closed and sealed package; and subjecting an outer surface of the package to gaseous pressure which causes the packaging material to exert pressure on the contained cheese, sufficient to cause the cheese to flow, relative to the finishing mold elements, and along and into respective contours at the inner surfaces of the mold elements, whereby the finished shape of the so-formed cheese product closely reflects the interior surfaces of the finishing mold elements while the interior surfaces of the mold elements substantially retain their shapes.

In some embodiments, the method further comprises, prior to placing the cheese in molding relationship to the at least first and second finishing mold elements, providing the mass of cheese particles in working relationship with one or more pre-form molds, which generally reflect the desired finished shape, and which are over-sized with respect to the size and/or shape of the desired cheese product, in gross outline, in at least one of mutually perpendicular “X”, “Y”, and “Z” axes, and applying differential pressure to the pre-form molds, and through the pre-form molds to the cheese particles while the cheese particles are at temperatures substantially below the melting temperature of the cheese, thereby to cold-form the cheese into a relatively higher density cheese pre-form which generally reflects the desired finished shape of the cheese product, and which contains a quantity of cheese closely corresponding to the quantity necessary to fabricate a cheese product of the desired finished shape and size, the placing of the cheese in molding relationship to the at least first and second finishing mold elements comprising placing the cheese pre-form in molding relationship to the at least first and second finishing mold elements.

In some embodiments, the method further comprises, prior to subjecting the outer surface of the package to the gaseous pressure, placing the combination of the cheese and the finishing mold elements in a bag, and subsequently performing the evacuating of air from the combination and the sealing of the packaging structure, the sealing of the packaging structure comprising at least in part forming a closure seal to thereby seal the bag.

In an eleventh family of embodiments, the invention comprehends a method of making a cheese product into a desired finished shape and size of up to about 3 ounces, optionally up to about 2 ounces, or up to about 1 ounce, after forming cheese curd into a consolidated block of cheese. The method comprises comminuting the cheese thereby to form a mass of cheese particles; providing a portion of the mass of the cheese particles, generally reflecting the desired mass of the finished cheese product, in working relationship overlying a cavity in a finishing mold, which reflects the desired finished shape of a substantial portion of the outer surface of the cheese product; providing a cover over the portion of the mass of cheese particles and generally overlying both the cheese particles and the cavity in the finishing mold, with the cheese between the cover and the cavity; collectively closing off the combination of the finishing mold, the portion of the cheese particles, and the cover, from ambient air, and evacuating air from the collective combination, and applying sealing closure about the combination of the finishing mold, the cheese particles, and the cover, thereby to provide a closed package; and applying differential pressure to the mold and the cover, and through the mold and cover to the cheese particles, while the cheese particles are at a temperature substantially below the melting temperature of the cheese, thereby to cold-form the cheese particles into the cavity in the finishing mold such that the cheese particles re-knit to each other and flow to conform to the inner surface of the finishing mold, with the cover optionally flexing toward the cavity of the finishing mold, thereby to encourage movement of the cheese particles into the cavity whereby the finished shape of the so-formed cheese product closely reflects the interior surfaces of the finishing mold elements while the interior surfaces of the mold elements substantially retain their shapes.

In some embodiments, the cover comprises a backing sheet.

In some embodiments, the cover is comprised in a bag.

In some embodiments, the cover comprises a plunger.

In a twelfth family of embodiments, the invention comprehends a method of providing a cheese product, comprising cheese which has reached at least the stage of development of curd, the cheese product having a relatively stable desired finished shape and size at 44 degrees F., optionally at 35 degrees F., after the cheese product is made. The method comprises providing a packaging receptacle, as a packaging material, adapted and configured to receive such cheese thereinto; injecting into the packaging receptacle, through an orifice having an open area corresponding to a diameter of about 0.19 inch to about 0.50 inch, a flow of the cheese, in a warm condition substantially below a melting temperature of the cheese, such that the cheese is readily flowable as a viscous fluid, but is not in a condition which is generally considered to be liquid; facilitating release of air from the packaging receptacle consistent with the injection of the cheese into the receptacle; providing a closed and sealed packaged cheese product, containing the cheese, by providing a closing and sealing packaging closure, optionally as a second packaging material over the receptacle, and effecting closure thereof; and holding the packaged cheese product in such package for a time sufficient to substantially fully conform the cheese product to the receptacle and/or to substantially congeal together the cheese product in the desired finished shape and size.

In some embodiments, the method further comprises removing the cheese product from the packaging materials, whereupon the cheese product when at 44 degrees F., optionally at 35 degrees F., when removed from the packaging materials, effectively retains substantially the same size and shape as when packaged, for at least 30 minutes in an environment wherein air temperature is 73 degrees F.

### BRIEF DESCRIPTION OF THE DRAWINGS

FIG. 1 shows a bottom pictorial view of a packaged cheese product of the invention, in the shape of a football.

FIG. 2 shows a bottom pictorial view, with parts cut away, of a packaged cheese product of the invention as in FIG. 1, but with a small flat surface element at the bottom of the football.

FIG. 3 shows a bottom pictorial view of a packaged cheese product of the invention in the shape of the top half of a football, similar to FIG. 1 but missing the bottom half of the football shape

FIG. 4 shows a cross-section of the cheese product of FIG. 2, taken at 44 of FIG. 2.

FIG. 5 shows a close-up view of a lacings portion of the football packaged cheese product of FIG. 1.

FIG. 6 shows a representational side elevation view of a set of pre-form molds useful in the invention, with a block of cheese illustrated between pre-form mold members.

FIG. 7 shows a representational side elevation view of the set of pre-form molds of FIG. 6, but showing a mass of comminuted cheese particles illustrated between the pre-form mold members instead of the block of cheese.

FIG. 8 shows side pictorial representations of upper and lower finishing mold elements useful in the invention, wherein one of the mold elements employs a plunger.

FIG. 9 shows side pictorial representations of upper and lower finishing mold elements as in FIG. 8, wherein the lower finishing mold element comprises an unformed backing sheet.

FIG. 10 shows an inner chamber of an interior vacuum forming machine useful in methods of the invention, and containing a cheese product to be vacuum molded in a set of finishing mold elements, the product and finishing mold elements being enclosed within a bag, a mouth of the bag being disposed between two sealing jaws.

FIG. 11 shows product, finishing molds, and encompassing bag as in FIG. 10, but in ambient atmosphere, with a nozzle of an external vacuum machine imposed in the mouth of the bag, between a pair of open seal jaws.

FIG. 12 shows a top view of a finishing mold element having a plurality of relatively smaller cavities in a single mold element, and wherein loose particles of comminuted cheese overlie one of the cavities.

FIG. 13 shows a top view of an angel figure cheese product of the invention, having a variety of bas relief surface configurations, including isthmus structures connecting wings of the angel to the main body of the angel.

FIG. 14 shows a side elevation line drawing of a fully 3-dimensional cheese product in the shape of a dinosaur, made according to the invention.

FIG. 15 shows a side elevation of a fully 3-dimensional cheese product in the shape of a dinosaur as in FIG. 14, but in true pictorial format to better illustrate the 3-dimensional configuration.

FIG. 16 shows a mold in the form of a teddy bear, useful in the invention in an injection molding process by which cheese which is not readily flowable is injection molded in a mold.

FIG. 17 shows a side pictorial view of an angel mold, useful in making angels as in FIG. 13, filled with what is commonly sold commercially to retail consumers as cheese curd, and prior to forming such curd into a respective angel-shaped cheese product.

FIG. 18 shows a representation of a side elevation of a cheese product made in the shape of a pineapple, including both the lower fruit body and a set of upper leaves extending from the fruit body.

This invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

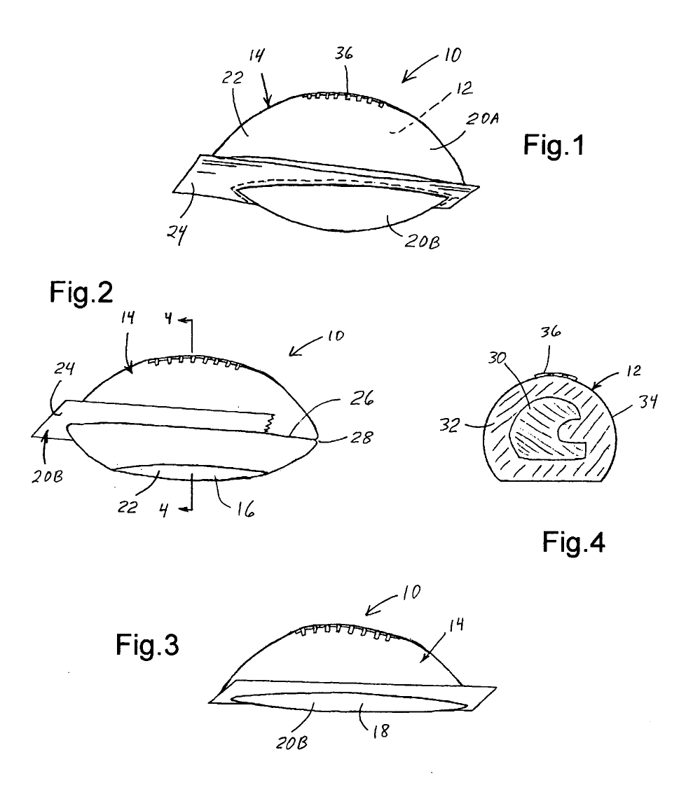

FIG. 1 illustrates a packaged product 10 wherein a cheese product 12, in the shape of a football, is contained within packaging structure 14 which is closed and sealed about the cheese product. FIG. 1 thus represents a fully 3-dimensional product, such that the product has no flat sides.

FIG. 2 shows a packaged product 10 as in FIG. 1, but wherein a relatively small portion of the lower half of the football has been eliminated, leaving a flat surface 16 at the bottom of the football as a stabilizing base for setting the packaged cheese product, alternatively the cheese product removed from the packaging material, on an underlying substrate such as a table, a plate, or the like. FIG. 2 thus represents an almost fully 3-dimensional product in that it has a flat spot, albeit it small one, on one side of the product, but the product is otherwise devoid of flat spots of any substantial size. Such almost fully 3-dimensional product is referred largely to herein as a 2.75D product.

FIG. 3 shows a packaged cheese product 10 as in FIGS. 1 and 2, but wherein the entire lower half of the football has been eliminated, leaving a flat surface 18 representing a longitudinal section through the football shape at substantially the largest area section of the football shape. FIG. 3 thus represents essentially half of the shape of a football, taken along the longitudinal centerline of such football representation. FIG. 3 thus represents a 3-dimensional product wherein substantially a mirror image of the respective product is required to complete the representation of the product being represented. Such half-image product is referred to largely herein as a 2.5D product.

As alluded to above, the invention is directed, to some extent, though not as a limitation, to fabricating cheese and other food products in the shape of a wide variety of known products or other images which are other e.g. different food products such as non-cheese products or non-meat products, or which are non-food products or are related to other non-food images, or other things or actions or services. Accordingly, the food product, e.g. cheese product of the invention, conjures up, e.g. in the mind of the consumer of such food product, an image or other memory of the other product or thing or action or service being represented.

By presenting the food product of the invention in a different form of the other product, or action or service, the purveyor of such food product can engage in a form of marketing or advertising of the other product or action or service wherein the food product is the medium by which the marketing or advertising message is conveyed.

The advertising or marketing message can be further enhanced by providing coloration on the food product which represents one or more colors or color patterns with which the non-food product or service is commonly identified in commerce. For example, where the non-food product or service is identified with the colors green and gold, the cheese product can be colored with a pattern of green and gold representative of the hues of green and gold associated with the non-food product or service.

Where color pattern is also part of the product identification of the non-food product or service, such color pattern can be copied or otherwise simulated on the food products of the invention.

Such color or color pattern can be incorporated in the food product by printing, or by adding a thin layer of the appropriately-colored food to the finishing mold before the mold is activated in forming the food into its finished shape, as further described hereinafter.

Still addressing FIGS. 1-3, the size of the food product is not generally a part of the invention, except where otherwise pointed out, such as bite-size items. Thus, the football-shaped products illustrated in FIGS. 1-3 can be any size from bite size, e.g. about 1 ounce, up to any size desired, including hundreds of pounds of cheese. The size of the product does have some bearing on the structure of the molds which are used in fabricating the cheese into the desired shape.

The packaging structure 14 in the packages of FIGS. 1-3 is in part defined by first and second finishing mold elements 20A, 20B which, after the cheese is molded in the finished shape, serve as portions of the packaging structure. Each mold element has a forming body 22 and a flange 24 extending from the forming body. Note in FIGS. 1 and 2 that the formed product faithfully includes the side seam 26 which is normally found in a leather football, which illustrates that the products of the invention can include a wide variety of detail, including undercuts and back-fills, as the process of the invention is amenable to such mold features, product features. Note also that FIG. 2 illustrates the concept that the end tucks 28 normally found in a leather football are shown, and are enabled by the methods of the invention.

FIG. 4 is a cross-section of the food product of FIG. 2. FIG. 4 illustrates the capability of the invention to fabricate a first three-dimensional cheese or other food body 30, and to form a second generally outwardly-disposed three-dimensional food body 32 about the first food body. In the alternative, the second food body can be formed about less than all of the first food body, whereby a first portion of the outer surface 34 of the composite product is represented by the first food body, and a second portion of the outer surface of the composite product is represented by the second food body. Such composite food body is fabricated by first fabricating the first/inner food body 30 according to methods taught hereinafter for fabricating a shaped cheese product, and then positioning the material of the second food body about the first food body, and again passing the composite composition through the fabrication process a second time, thereby to consolidate the second food body about the first food body.

Still referring to FIG. 4, at least one of the first and second food bodies is a cheese product, while the other food body can be a food other than cheese. For example, the inner, first food body can be sausage or other fabricated meat product, while the outer, second food body is cheese. As a second example, the inner first body is cheese and the second outer food body is sausage. Such layered, or composite, fabrication can be employed so long as the non-cheese product can be fabricated according to the methods taught hereinafter. Typically, the fabrication requirements can be met so long as the e.g. meat product is in a form which can be caused to flow by applying a pressure differential corresponding to atmospheric otherwise. For example, many sausage products are fabricated from ground meat products, which can be caused to flow under pressure conditions similar to those conditions which cause cheese to flow. Each food product has its own set of conditions, but all such sets of conditions are within a small subset of pressures and temperatures, optionally with the addition of very minor amounts of edible oils or other materials as lubricants, optionally with the inclusion of spices or other flavorings.

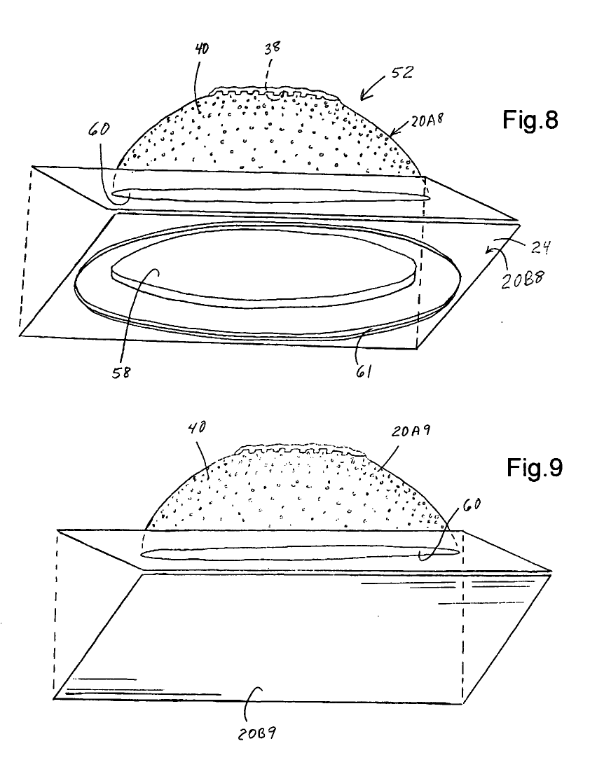

FIGS. 1-3 indicate the presence of a representation 36 of the lacings of the non-food product leather football. As will be seen hereinafter in the discussion of FIGS. 8-9, the inner surface of the finishing mold can be fabricated to include substantial detail of the outer surface of the non-food product. In this case, upper finishing mold element 20A includes recesses 38 which correspond with the physical outline of the lacings on a conventional non-food leather football.

Where the cheese product is fabricated using only a single cheese product, the lacings shape is fabricated from the same cheese as is used to fabricate the main body of the cheese football product. As desired, the molded cheese football can be removed from the mold, and printed or otherwise colored with e.g. a white color, food grade ink at the lacing impressions. Alternately, the colorants may be applied to the food product before molding or colorants, spices, or other surface coatings can be applied to the finishing mold elements, thus avoiding repackaging. In the alternative, a suitable-color cheese or other food product, having suitable consistency, e.g. moldable but not liquid, can be placed in the lacing recesses in the respective finishing mold element, as a lacing precursor, before activation of the finishing mold element in fabricating cheese into the cheese football, whereupon activation of the mold elements in fabricating the cheese football, is effective to move the lacing precursor fully into the lacing recesses in the mold element. In the resultant cheese football product, the lacing material has become fully knit with, incorporated into the body of, the main body of the cheese.

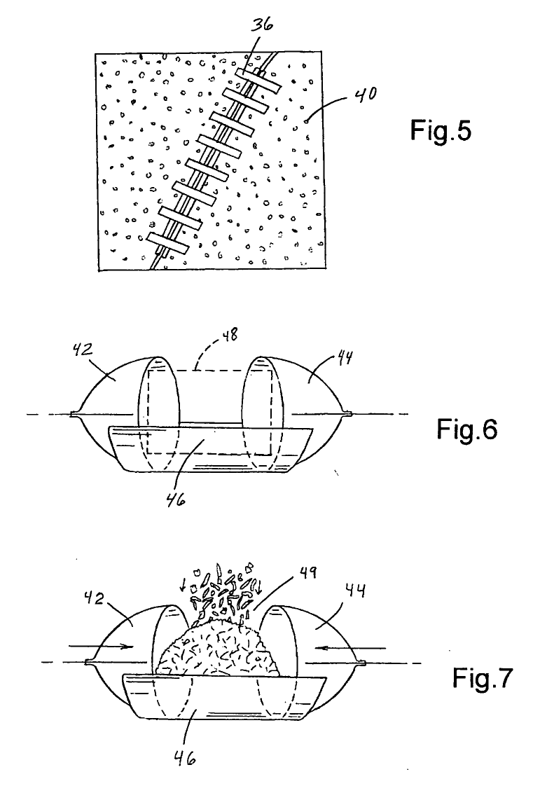

FIG. 5 further illustrates a large number of protrusions 40 which protrude from the main mass of the football cheese product, in representation of the fine detail of the protrusions normally extant on a non-food pebble-grain surface, or leather, football. FIG. 5 thus illustrates that, substantially to the extent surface detail can be defined in the inner surface of the finishing mold, such extent of surface detail can be defined in the outer surface of the cheese products of the invention.

FIGS. 6 and 7 illustrate the concept of making a cheese pre-form as a preliminary step, before fabricating the cheese into the finished desired shape and size. FIG. 6 illustrates making a cheese pre-form from a solid consolidated block of cheese, e.g. a block of 2-year old cheddar. FIG. 7 illustrates making a pre-form from a mass 49 of comminuted particles of cheese, such as shredded cheese, cheese pellets, or pea-size particles of cheese.

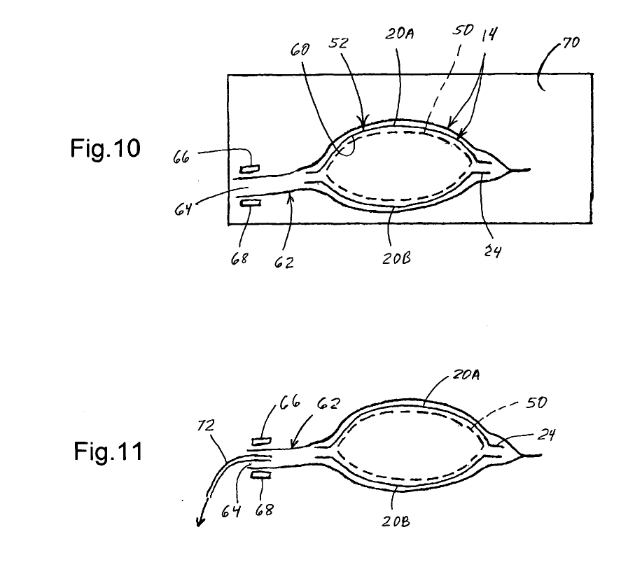

Turning now to FIGS. 6 and 7 in detail, a cheese pre-form 50, illustrated in FIGS. 10 and 11, is made using a set of pre-form molds, generally including a first e.g. left mold 42 and a second e.g. right mold 44. A pre-form mold guide 46, generally cylindrical in outline, underlies a space by which the molds are separated when the molds are open, and in condition to receive a fresh charge of cheese or other flowable but non-liquid food product.

With the molds spaced from each other as shown in FIGS. 6 and 7, a charge of cheese is placed between the pre-form molds. FIG. 6 shows a consolidated block of cheese 48 in dashed outline between the pre-form molds. FIG. 7 shows a mound of comminuted cheese particles between the pre-form molds. With the cheese positioned between the molds, and generally confined within the projected outlines of the molds as taken in alignment mold-to-mold, the molds are forced closed.

In the case of the particles of cheese, the particles are forced together, whereby the particles begin to knit to each other, and the outer surfaces of the mass generally conforms to the inner surfaces of the pre-form molds.

In the case of the block of cheese, as the pre-form molds are moved toward each other, the molds encounter the ends of the block of cheese. As the molds continue to press against the ends of the block of cheese, the cheese flows in accord with the mold surfaces which are encountered. While the process can in some instances be performed at the typical refrigeration temperature of cheese, of about 44 degrees F, as necessary, or as desired, the cheese block can be pre-warmed to a warmer temperature, thereby to soften the cheese such that the cheese can be more readily made to flow, form e.g. with a reduced amount of molding force. However, the cheese should not be melted, as melting typically changes the texture of the cheese in an undesirable way. Accordingly, any pre-warming typically warms the cheese to a temperature not less than 30 degrees below the melting point of the cheese. Thus, if the melting point of the cheese is 110 degrees F., the maximum desired temperature to which the cheese is warmed is 80 degrees F.

The shape of the cheese pre-form 50 which is fabricated in the pre-form molds closely resembles the specified shape and size of the finished cheese product. Where the pre-form has been made from a cheese block, the outer surface of the pre-form should come within 0.25 inch, optionally within 0.13 inch, of the finished specified shape and size, about substantially the entirety of the outer surface of the finished cheese product. In some instances, the cheese pre-form will in some areas of the pre-form be larger in dimension than the specified dimensions of the finished cheese product and in other areas may be smaller in dimension than the specified dimensions.

Where the cheese pre-form has been made from comminuted cheese particles, the size and shape of the cheese pre-form generally correspond to the specified finished shape. However, the density of this pre-form is less than the density of a pre-form made from a cheese block, whereby the particle pre-form is generally larger in at least one dimension than the specified size and shape of the finished cheese product. Typically, such pre-form is about 8-12% oversize compared to the specified size and shape of the finished product.

Referring to FIGS. 10 and 11, after the cheese pre-form has been made, the cheese pre-form is placed in working relationship with a finishing mold 52 having one or more finishing mold elements, illustrated in FIGS. 8 and 9 at 20A8 and 20A9, 20B8, and 20B9. FIG. 8 shows an upper finishing element 20A8 having the configuration of half of a football; and a lower finishing element 20B8 which is generally flat, but which incorporates a plunger 58 which intrudes into the cavity 60 in the upper finishing element 20A8 as the mold is moving the cheese into its finished size and shape during the finishing molding process. A mold reinforcing rib 61 encompasses plunger 58, outwardly on flange 24.

The finishing mold of FIG. 9 also illustrates an upper finishing element 20A9 substantially the same as the finishing mold element 20A8; and a lower finishing element 20B9 which is generally flat, and generally functions as a backing element in the finishing molding process.

The basic task of the finishing mold elements 20A, 20B is to receive a working mass of cheese or other food product and to fabricate the working mass into the finished size and shape. The working mass can be received as a cheese pre-form from pre-form molds 42, 44. In the alternative, the finishing molds receive non-consolidated cheese in other than a pre-form configuration, such as an unconsolidated mass of cheese particles, or a loosely consolidated mass of cheese particles.

The force used in forming a cheese pre-form is about 100-2500 pounds per square inch (psi) force, optionally about 300-1800 psi, or about 500-1500 psi, measured at the inner surfaces of the pre-form molds. A loosely consolidated mass of cheese is formed using e.g. about 5 psi to about 50 psi force at the surface of the mass of cheese. An unconsolidated mass of cheese can be pre-formed to a minor degree, using force in an amount of only slightly more than zero psi up to about 5 psi. In any event, the amount of force is determined as that amount of force which is needed to form and condition the cheese mass such that the specified size and shape can be obtained in the finishing molding process, especially where the specified size and shape can be obtained using ambient atmospheric pressure.

The mass of cheese needed for the specified size and shape, and wherein the cheese is fully knitted together, can be determined in a routine manner. Given the needed amount of cheese, a suitable amount, weight, of cheese can be provided to the pre-form operation whereby the pre-form contains the needed mass of cheese. In the alternative, the pre-form can contain slightly less than the specified amount of cheese, e.g. up to about 5 percent less, whereupon additional cheese can be added at the finishing molding step. Where the pre-form step is by-passed, the needed amount of cheese is provided at the finishing mold elements.

If too little cheese is provided at the finishing mold, the mold may buckle, resulting in a depression in the resultant cheese product. If too much cheese is loaded at the finishing mold, a certain amount of flashing may develop between the flanges 24 of the finishing mold elements during the finish molding process. A desired resultant product can be obtained within a mass window, which varies for each different cheese product. For example and without limitation, a mass of plus 6%, minus 0%, from target mass, is a representative mass window for certain of the cheddar cheeses.

Turning now to FIGS. 10 and 11, a wide range of the products of the invention can be made by fabricating a closed package about cheese product 12. Air is evacuated from the closed package thereby to create a vacuum, or partial vacuum, inside the package and subsequently, optionally concurrently, applying atmospheric pressure to the outside of the package whereby the atmospheric pressure on the outside of the package, when balanced against the evacuation pressure, vacuum, inside the package applies a net positive inwardly-directed force on the outside of the packaging material. The packaging material is thus urged inwardly, away from the outer surface or surfaces of the packaging material and in general toward the contained cheese product.

At this stage, the cheese product may have been formed into a pre-form which generally reflects the overall shape of the specified finished product, albeit perhaps in a somewhat larger representation of the finished product in at least one dimension.

For example, FIGS. 10 and 11 show the upper and lower finishing mold elements 20A and 20B spaced from each other at flanges 24. Such spacing of the flanges from each other is an indication that the top-to-bottom dimension of the cheese pre-form 50 is greater than the top-to-bottom dimension specified for the finished product.

If the cheese has not been formed into a pre-form by e.g. a pre-forming operation, the cheese is in the form of e.g. comminuted particles. The particles have been arranged in some fashion whereby the requisite quantity of cheese is at least operatively positioned and arranged with respect to the finishing mold elements, and has been at least manipulated, e.g. by hand, to such extent that the cheese remains in operative working relationship with respect to the finishing mold elements. For example, and referring to FIGS. 10 and 11, the cheese particles are between the mold elements and are within the vertical projection of the mold elements.

As a substantial portion of the physics necessary for this invention to work in the fabrication of cheese products from cheese particles, it is important for the cheese particles to be amenable to knitting together as the particles are brought into proximity with each other under the force of atmospheric pressure applied to the outside of the package when the air pressure has been withdrawn from the inside of the package. Stated another way, when pressure is applied to the cheese particles, urging the particles into contact with each other, it is important that the cheese particles be able to knit, or fuse, together to thereby generate a unitary cheese body. Such fusing or knitting together of cheese particles is a natural characteristic of cheese products of the invention.

Such natural knitting or fusing properties are commonly undesired in consumer packages of shredded cheese products, whereby such knitting or fusing properties are defeated by coating the shredded cheese with flour or other material which interferes with the fusing, knitting properties. It is important to the invention that the cheese particles not be treated in any way which defeats the knitting, fusing properties of the cheese particles, prior to the fabrication of the cheese into the specified size and shape.

FIGS. 10 and 11 also show a bag 62, typically a heat sealable bag, encompassing both the cheese and the finishing mold elements. Bag 62 is closed except at mouth 64. Mouth 64 is positioned between upper 66 and lower 68 seal bars, typically heat seal bars.

FIG. 10 illustrates the cheese, the finishing mold elements 20A, 20B, bag 62, and seal bars 66, 68, inside a vacuum chamber 70 in a vacuum seal machine wherein vacuum is drawn on, and air is thus evacuated from, a closed and sealed chamber, and wherein a heat seal is applied to the bag or other packaging structure while the vacuum is being held in the respective chamber, thereby to provide the final closure and sealing to the packaging material in making the closed and sealed package. Such machines can be obtained, for example, from Koch Equipment LLC, Kansas City, Mo., and others. At that stage of the operation, both the inside of the package and the outside of the package are being subjected to the same level of vacuum, pressure, namely a very low absolute pressure.

Atmospheric air pressure, e.g. 14.7 psi, is then re-introduced into the vacuum chamber after the bag has been sealed. As the air pressure is re-introduced into the vacuum chamber, the pressure on the outside of the bag builds while the pressure on the inside of the sealed package remains at the low vacuum pressure level developed under the previous vacuum conditions. The closure of the bag has by then sealed off the contents inside the bag from any ingress of air into the bag when air is re-introduced to the vacuum chamber.

Accordingly, as the air pressure rebuilds inside the vacuum chamber, the air pressure on the outer surface of the bag pushes the bag inwardly toward the finishing mold elements. The finishing mold elements react by passing the force of the bag inwardly against the cheese, thus causing the cheese to flow away from the pressure. As the cheese flows away from the pressure, the cheese flows together, filling holes or other void spaces between respective ones of the cheese particles, and/or filling spaces between cheese particles and portions of the inner surface of the finishing mold elements.

Where the cheese is present in the form of a cheese pre-form, the cheese flows so as to fill any holes or other void spaces between elements of the pre-form, and to fill any spaces between the pre-form and the finishing mold elements. Such flow of the cheese is possible by virtue of the fact that cheese is a viscous liquid at typical operating temperatures.

There are a wide range of cheeses which can be fabricated according to the invention. The operating temperature depends on the specific cheese which is to be fabricated. Parameters which affect such operating temperature include, for example and without limitation, variety of the cheese, moisture and fat content, salt content, age of the cheese, specific formulation of the cheese, past temperature conditions to which the cheese has been subjected, past applications of shear forces on the cheese, and the like. Typically, however, the cheese can be fabricated using the methods taught herein at temperatures in the range of about 44 degrees F. to about 80 degrees F. Relatively lower temperature is generally preferred in order to better preserve a low bacteria count in the cheese. However, lower temperatures tend to require more energy in the fabrication, molding process, in order to get the desired result of size and shape. The warmer the cheese the faster the cheese flows, but the greater the risk of undesirably increasing the harmful bacteria count in the cheese. Thus, selection of fabricating temperature is a balance of ease of fabrication compared to affect on the desirability of the resultant product e.g. texture, for human consumption of the cheese.

Returning now to the drawings, FIG. 11 shows the same cheese product, juxtaposed in operating relationship with upper and lower finishing mold elements 20A, 20B, all inside bag 62. The open side or mouth 64 of bag 62 is positioned between upper and lower seal bars 66 and 68. A nozzle 72 is imposed into the open mouth 64 of the bag, and is located between the seal bars 66 and 68. Seal bars 66 and 68, in combination with bag 62 define a combination which is sufficiently resilient that the seal bars can be closed on mouth 64 so as to close the bag to the outside environmental pressure while maintaining nozzle 72 in the inwardly-intruding location shown in FIG. 11 with an open air passage through nozzle 72 and protruding into the inner chamber defined inside bag 62, inwardly of the seal bars 66 and 68.

With the nozzle in the location shown, such that the nozzle can communicate with the interior of the bag, even with the seal bars closed against each other and with the bag between the seal bars, the seal bars are closed about the nozzle and on the bag. Nozzle 72 is connected to an external vacuum source. Any vacuum source having suitable rate of draw can be used, so long as a connector can be provided connecting to nozzle 72. External vacuum devices are available, for example, from Doug Care Equipment, Springville, Calif. A wide variety of suitable vacuum devices are available from a variety of vendors of vacuum supplies.

With the vacuum nozzle connected to a suitable vacuum source, with the seal bars closed about the bag mouth, air is withdrawn from the bag whereby the air pressure inside the bag is reduced in accordance with the evacuation of the air from the bag. In common vernacular, a vacuum is drawn inside the bag.

As the air pressure inside the bag is reduced, ambient e.g. atmospheric air pressure outside the bag continues to press on the outer surface of the bag, urging the bag inwardly toward the finishing mold elements, and thus toward the cheese. Since the air pressure inside the bag is being reduced, the pressure differential across the thickness of the bag increases, resulting in a net increase in the pressure differential between the inside of the bag and the outside of the bag. Optionally, additional pneumatic or mechanical forces can be applied in addition to atmospheric pressure. Any of such forces can be applied to an already-packaged food product which is already sealed in packaging material, thus shaping the already-packaged food in the package by using the finishing mold elements to apply external pressure to the outside of the package. Thus, the invention can be applied as an in-package forming operation, post-forming the already-packaged e.g. cheese after such food product after such food product has been packaged in a closed and sealed, but flexible, packaging material.

As discussed above with respect to the step of re-introducing atmospheric air pressure inside the chamber of an inner chamber vacuum machine represented in FIG. 10, the pressure of the air outside the bag causes the bag to move inwardly, and to collapse toward, the finishing mold elements and the cheese. Also reflecting on the discussion with respect to FIG. 10, the finishing molds press against the cheese, causing the cheese to flow to fill in voids internal to the cheese and between portions of the cheese or elements of the mass of cheese, as well as to move into, and fill in, spaces between the cheese and the inner surfaces of the finishing mold elements.

Once the desired level of evacuation has been achieved, namely when the vacuum level has reached the desired intensity, nozzle 72 is withdrawn. As the nozzle is withdrawn, the space occupied by the nozzle is correspondingly and at the same time filled in by resilient restoration of one or more elements of the dimensions of seal bars 66 and 68, whereby the closure of the bag, which is being held by the seal bars, is maintained as the nozzle is withdrawn.

After, or concurrent with withdrawal of the nozzle, and with the seal bars still clamping the bag closed at mouth 64, sealing heat is applied to seal bars 66, 68 such as through heaters embedded in the seal bars, thereby developing a permanent, optionally a peelable, seal at mouth 64 of the bag.

The overall result of the closing and sealing operation just described is to provide a closed and sealed package defined by a bag as the outer layer, an inner layer defined at least in part by the finishing mold elements, and a cheese or other food product contained in the package inwardly of the finishing mold elements.

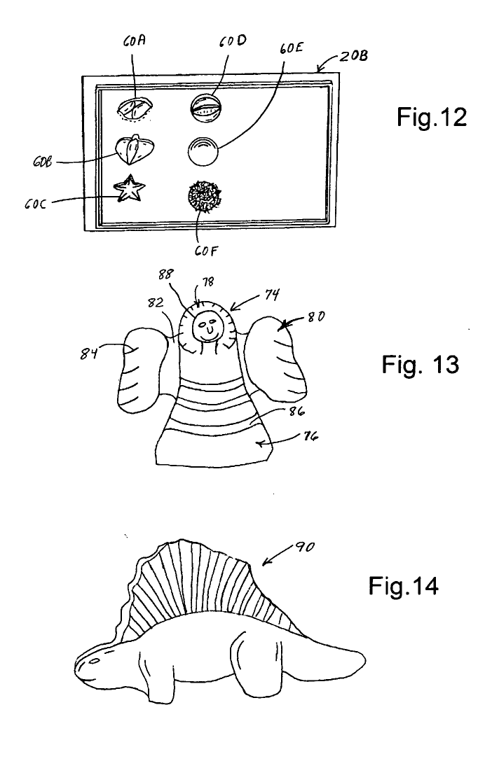

A substantial benefit of the invention is that, in light of the methods disclosed herein, cheese and other food products, which generally hold their shape under ambient pressure, and temperature conditions normal to storage of that food product, can be molded into a wide variety of shapes which have not heretofore been available. While the molding has been described above as molding the cheese product in at least one dimension, by proper selection of the molds, mold materials, mold dimensions, and molding assists, a cheese product can in fact be molded about the full 360 degrees encompassed by a product in any or all of the “X”, “Y”, and “Z” planes. Without limitation, FIGS. 12, 13, 14, 15, 17, and 18 represent product shapes which can be successfully molded using the methods described above. A wide variety of other products can also be molded using the same or similar processes, or processes derived from the above described processes.

Starting with FIG. 12, there is shown a lower finishing mold element 20B which contains multiple cavities 60 into which cheese is received for molding. The cavities in FIG. 12 represent a variety of shapes and configurations from the known to the fanciful. For example, cavity 60A represents a fanciful and modified ovoid object having multiple depths. Cavity 60B represents a basic heart outline, with modifications. Cavity 60C represents a conventional 5-pointed star wherein the depth of the star increases gradually from all sides toward the center. Cavity 60D represents a circular structure having multiple step changes in depth. Cavity 60E represents a conventional hemisphere or mini half baseball or mini half basketball. Cavity 60F represents a figure circular in length and width and undefined of a depth configuration which cannot be determined by inspection of FIG. 12.

While the depth configuration is undefined, any desired depth configuration consistent with the various figures, and the discussion of shapes herein is satisfactory. Rather, the focus of cavity 60F is to show a mass of shredded cheese overlying the cavity in a normal configuration of such unconsolidated mass immediately prior to application of a backing sheet, as a second finishing mold element, over the mold element shown.

With cheese particles applied over all of the cavities for which a product is desired, only one of which is shown at 60F, a backing sheet is applied over at least that portion of the surface of mold element 20B which is to be molding cheese, the mold element combination is placed in a bag, and vacuum is drawn as taught above. As the pressure differential develops inside the package, both the backing sheet, as the upper mold element 20A, and the lower mold element 20B, apply pressure on the cheese.

While the backing sheet can include a plunger 58, it is entirely possible that the backing sheet is without defining structure, and is a generally flat sheet. With the backing sheet being without structure, and assuming generally common thicknesses between lower mold element 20B at a cavity e.g. 60F and the backing sheet, the backing sheet will absorb relatively less of the pressure differential than will the lower mold element, whereby the distance of movement, the amount of movement, of backing sheet 20A is substantially greater than the amount of movement of the inner surface of lower mold element 20B at cavity 60F. Thus, typically, an unsculpted backing sheet tends to form a slight depression in the respective package surface formed by the backing sheet.

However, the relative distances of movement of the respective finishing mold elements 20A, 20B, can be choreographed by the user as desired by e.g. selection of materials for mold elements 20A, 20B, relative thicknesses of mold elements 20A, 20B, and by the nature of the three-dimensional profiles of either or both of mold elements 20A, 20B, and control of various other parameters.

In general, movement of the finishing mold elements toward each other in molding the cheese does not compromise the overall configuration or shape of the outer surface of the resultant cheese product, whereby the configuration and shape of the resultant cheese product can reflect quite faithfully the overall outlines of the inner surfaces of finishing mold elements 20A and 20B prior to molding the cheese.

To the extent the molds themselves are reconfigured, such as bent, impressed, or the like during the molding process, and to the extent such reconfiguration is not reversed by the end of the molding process, the desired shape of the finished product can have been compromised in that product. Where such change can be predicted, or is known, such reconfiguration of the mold during the molding process can be taken into consideration in design of the mold, either by strengthening the mold to prevent such reconfiguration, or by adjusting the mold configuration such that the reconfigured outline, produced in the molding process represents the desired shape and size.

Finishing molds 20A, 20B are typically made of various ones of the thermoformable polymers such as, without limitation, the polyethylenes and their copolymers, the polypropylenes and their copolymers, the polyethylene terephthalates, the polyamides and their copolymers, the vinyl chlorides and their copolymers and the vinylidene chlorides and their copolymers. Thickness of the finishing mold elements is a judgment considering desired flexibility of the mold to enable conformity to various cheese flows and releases, cost, strength against collapse of mold features, cost of materials and processing, and the like.

One common method for fabricating molds 20A, 20B is to thermoform flat sheets of the selected material about either a male mold or a female mold. Levels of strength are influenced by material selection and resultant thickness of the cavity walls after thermoforming, among others.

Where additional strength is desired, the finishing mold elements can be fabricated by e.g. injection molding processes. Injection molding processes lend themselves to incorporating e.g. strengthening ribs or other areas of relatively greater, or lesser, thickness at any desired locations in the finishing mold elements. Injection molding thus provides the capability to carefully control the flexing of the mold element during the molding process according to thickness of any given area of the mold element. For example, a first area may need reinforcing in order to control undesired levels of flexing, while a second different area may need no such reinforcing.

The thickness of a thermoformed mold element is determined in part by the thickness of the selected sheet of material to be thermoformed. The overall thickness of the sheet is typically uniform, within conventional tolerances, about the area of the sheet before thermoforming. The thickness of the mold element at the cavity after thermoforming is less than the starting thickness, and varies about the cavity depending on a number of variables, two of which are depth of draw, and configuration of the cavity.

Exemplary of starting thickness of the material to be thermoformed into a finishing mold element, for making a cheese product using up to about 5 pounds of cheese is about 0.015 inch to about 0.020 inch. By the time the material has been thermoformed, the thickness of the material in the deeper draw areas of the cavity are about 0.008 inch to about 0.010 inch. Where larger cheese products are to be made, the starting mold material is generally thicker, to account for the additional thinning where a larger draw is required, and to account for a potentially larger area which may be spanned by a cavity 60 or a greater thickness of the finished product. Thus, pre-molding sheet thicknesses of about 0.025 inch to about 0.030, or greater, are contemplated for relatively larger cheese product shapes, e.g. up to about 10-20 pounds of cheese. Where a much larger cheese product is contemplated, e.g. 100 pounds or more, such correspondingly larger mold requires development of a correspondingly more robust mold in terms of wall thickness, reinforcing members, and the like.

Thickness of the mold element at the cavity 60 is comparatively less controllable for a thermoformed mold element and comparatively more controllable for an injection molded mold element 20A or 20B. However, given the relative costs of injection molding and thermoforming, given the fact that the finishing mold elements may be shipped as part of the package which contains the cheese product, cost of the mold elements suggests that, in certain instances, thermoformed or other relatively lesser cost mold elements represent a better selection for finishing mold elements 20A and 20B, rather than injection molded mold elements.

Returning to the drawings, FIG. 13 shows an angel 74 molded from cheese using finishing mold elements, and processes, of the invention. Angel 74 has a main body 76 including head 78, first and second wings 80, and first and second isthmus' 82 connecting the wings to the main body. In the embodiment illustrated, the main body and the wings have a first overall general thickness. Lines 84 extend to the outer edges of the wings and represent lines of minor depression in the upper surface of the respective wing. Bands 86 in the main body represent bands of minor depression in the upper surface of the main body. Lines 88 about the head and neck represent minor line-width depressions from the upper surface of the main body. Isthmus' 82 represent bands of depression between the upper surface of the main body and the upper surfaces of the wings.

Especially the bands 86 of depression and the isthmus' 82 of depression represent substantial departures from the thickness of the product at wings 80 and main-body 76. For example, if the top-to-bottom thickness at the main body and wings is 0.5 inch, the thicknesses of the cheese at bands 86 and isthmus 82 can be about 0.2 inch to about 0.4 inch, such that no common upper surface elevation exists between the wings and the main body or between the elevated portions of the main body and the bands 86. Of course, such descriptions are illustrative only in that the depressed areas can have a wide range of configurations, for example magnitude of depth, magnitude of width. Along the same line, the heights of the top surfaces of bands 86 or isthmus' 82 can be uniform, or can vary about the area of the respective band or isthmus. Angel 74 represents a configuration where the molded cheese product 12 has a generally flat or planar bottom surface (not shown) and a maximum height generally flat upper surface, but wherein a number of depressions are included in the upper surface, either as lines of depression or as bands of depression, and wherein both bands 86 and isthmus' 82 are bands of depression. Further lines of depression 84 and 88 are examples of bands of depression, of very limited width.

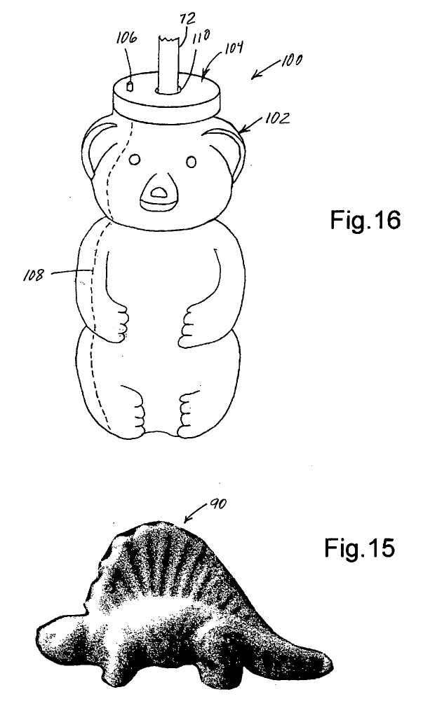

FIGS. 14 and 15 illustrate a cheese product 12 molded in the shape of a dinosaur 90. FIG. 14 is depicted as a line drawing. FIG. 15 is depicted as a copy of a photograph from which the line drawing of FIG. 14 was made. The purpose of presenting FIG. 15 is to better illustrate the true 3-dimensional nature of the molded product. One difference between the product depicted as angel 74 and the product depicted as dinosaur 90 is that the reverse side (not shown) of the product in FIG. 14 has a 3-dimensional surface much like the surface which faces the viewer. Namely, both of finishing mold elements 20A and 20B used in fabricating the product 12 contained cavities 60, for example as illustrated in FIG. 1.

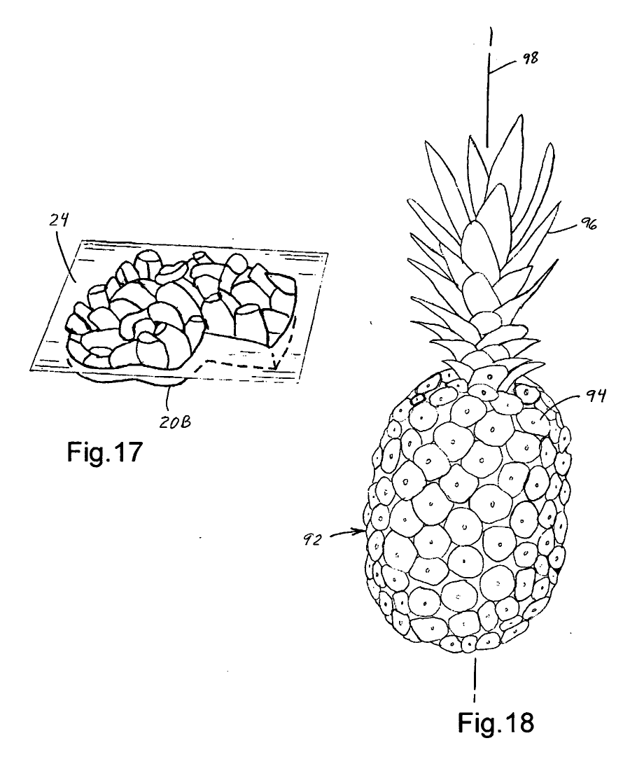

FIG. 17 illustrates that products of the invention can be made using a wide variety of cheese products. While harder cheeses are commonly used, such as cured cheddar, the more resilient cheeses can also be used. FIG. 17 illustrates the use of cheese curd, as is commonly sold to retail consumers in cheese-making areas of the country. Such curd is a very young cheese, and retains its “curd-like” qualities of taste and texture for a short period which can be measured in days, a rather small number of days, e.g. 2-4 days. Such curd is quite resilient, and tends, when deformed, even when deformed to substantial extent, to return to its previously existing shape and form.

Thus, the elements present in finishing mold element 20B are conventional pieces of cheese. Such cheese can be formed by e.g. placing a backing sheet, namely a plain sheet of finishing mold element material bearing no cavity, or a backing sheet bearing a plunger 58, over mold element 20B, and evacuating the interior of the mold as discussed above with respect to FIGS. 10 and 11 e.g. inside bag 62. The cheese curd elements readily deform in the mold, but are slow to actually form new curd-to-curd bonds which reflect the newly-acquired shape. Accordingly, when forming such uncured cheese, which is in the form of specific particles, the cheese must be held in the molded package for a prolonged period such as from about 8 hours to several days in order to provide adequate time for the spring-back properties inherent in such uncured cheeses to dissipate, and for the re-knitting process to progress sufficiently, that the cheese, when de-molded, will hold the specified shape and size and will have a uniform density and will be mostly free of spatial voids internally within the molded product.

On the other hand, many aged cheeses do not exhibit such spring-back properties, and so can be de-molded rather quickly, as desired, after completion of the applying of the pressure differential to the outside of the package. When the pressure differential is applied, one can watch as the cheese flows inside the package, filling cheese-to-cheese holes, and spaces between cheese and the inner surfaces of the packaging structure. When the flow stops, generally within about 10 seconds to a few minutes, the product can be removed from the package as desired without danger of the cheese product reverting substantially from the molded shape and size.

One might want to de-mold the product, for example, to consume the product. One might also want to de-mold the product in order to re-package the product in modified atmosphere packaging, such as with carbon dioxide. However, in many instances, the product is shipped to the ultimate consumer in the package whose creation, closure and sealing is illustrated in FIGS. 10 and 11. Examples of such packages are well illustrated in FIGS. 1-3.

Returning to description of the drawings, FIG. 18 illustrates a cheese product made in the form of a pineapple 92. The outer surface elements 94, referred to here as eyes, closely resemble in 3-dimension relief, the contours of such eyes in a pineapple. The product being represented here is indeed a food product, thus illustrating that the products of the invention, while typically representative of non-food products, can be foods of a different class from that of the material of which the invention is made. Eyes 94 collectively encompass the full circumference of the main body 76 of the pineapple, illustrating the principle that the surface impressions which can be molded into an e.g. cheese product of the invention can be directed inwardly into the body of the product from any and all angles defined by a sphere.

The top leaf portion 96 of the pineapple represents a rather more difficult feature to fabricate. For example, leaf portion 96 extends in rather thin segments generally outwardly from an upwardly extending axis 98. In fabrication of leaf portion 96, a relatively more resilient mold material is selected, such as a more heavily plasticized mold material or a mold material containing rubber components. Using such relatively more resilient mold material, a degree of reverse angles and undercuts can be made, and relatively thinner appendages can be fabricated. However, such thin section appendages, including undercuts, as shown for the top of the representational pineapple in FIG. 18 represent the outer limits of the current state of development of the processes taught herein.

Any product of the invention can be colored using conventional coloring tools. For example, food coloring can be mixed into the cheese. Food grade inks can be used to color the surface of the cheese, or a portion of the surface of the cheese, or can be used to e.g. print any message or image desired, using either contact printing or non-contact, e.g. ink-jet printing. Any food grade ink can be used so long as the resulting ink does not bleed substantially after printing, application of the ink. The specific selection of ink depends in large part on the method of application. Accordingly, various of the suppliers of such food-grade inks can instruct the user in suitable inks once the use is known. However, in the interest of ensuring adequate disclosure of an item which is already well known, an exemplary ink is “Soft Gel Paste food color, available from Americolor Corporation, Placentia, Calif.

Thin layer portions of colored food or other material can be mounted to the inner surface of a finishing mold element. One example of such other material is the lacings of the football in FIGS. 1-3. Such lacings can be, for example, thin strips of white cheese which are manually and lightly pressed into the string-forming recess portions of the upper finishing mold element. As the upper mold element applies pressure to the cheese pre-form, or the cheese particles, the thin layer of cheese in the strings portion of the mold, which covers only a small portion of what will be the outer surface of the football are pressed into full engagement with the inner surface of the mold, as well as being pressed into full engagement with the main body of the cheese product being formed. So long as the mounted material has a greater affinity for that portion of the surface of the main body of the cheese product against which it is being formed, the mounted material releases from the inner surface of the mole element when the product is de-molded from the mold, in preference to remaining attached to the mold element.

FIG. 18 illustrates yet another feature of the invention in that the leaf portion of the pineapple representation is molded separately from the main, fruit body portion, whereby the color of the leaf portion can be different from the color of the main body of the pineapple. Thus, where the main body can be, for example, a typical golden cheese color, the leaf portion is separately molded with cheese which is colored with green food coloring. In preparation for joining the leaf section with the main body portion, a shallow depression (not shown) is fabricated in the top of the main body. A corresponding shallow projection is molded in the bottom of the leaf portion. The leaf portion and the main body are then brought together, optionally shortly after the main body and the leaf portion have been de-molded from their respective molds. Accordingly, the leaf portion is brought over the main body, and gently pressed down against the top of the main body in order that the lower surface of the leaf portion be joined to the upper portion of the main body at the shallow depression. As desired, the depression can be deeper, and the projection correspondingly more pronounced, in order to facilitate more firmly joining the two body portions to each other.

FIG. 16 represents a further process for forming cheese into a three-dimensional shape, whether e.g. a full 3-D, a 2.75D, or a 2.5 D. In FIG. 15, a teddy bear-shaped cheese product 100 is being made. An e.g. injection molded, blow molded, or like receptacle mold 102 is employed in combination with a closure 104 over receptacle mold 102. In the illustrated embodiment, closure 104 serves largely as a containment cover. In some embodiments, cover 104 provides an air tight seal whereby a vacuum can be drawn on receptacle mold 102. Cover 104 includes a vent aperture 106, which can be a vacuum fitting in a vacuum-based operation. A line of weakness 108 in mold 102 can be used to de-mold the mold receptacle from the molded product. Line of weakness 108 can be e.g. a pair of first and second parallel lines of weakness, defining a tear strip therebetween. A second line of weakness (not shown), and optionally others, may be employed on the back or elsewhere in receptacle mold 102 to further facilitate removal of receptacle mold 102 from the molded cheese product.

Injection nozzle 72 extends through a fill hole 110 in cover 102. In a naturally vented process as shown, air is naturally exhausted through vent aperture 106 as cheese is being injected into mold 102 by nozzle 72. In such case a modest tolerance is employed between hole 110 and nozzle 72. In a vacuum process, vacuum is drawn on mold 102, through aperture 106, as cheese is being injected into mold 102. In such instance, a sealing clearance is maintained between nozzle 72 and hole 110, and cover 104 is at least temporarily sealed to receptacle mold 102.

In the injection molding process, the cheese is temperature-conditioned to a consistency wherein the injected cheese does not quickly flow to fill a receptacle, but does flow slowly over time of a few minutes to a few days to re-knit as a single unitary mass, generally free from holes within the cheese body and free from spaces between the cheese and the inner surface of receptacle mold 102. Such consistency can be thought of as a viscous liquid. Excessive shear in such viscous liquid cheese product can contribute to undesirable changes in texture of the cheese product, which can be subjectively detected by discriminating consumers of cheese. Any amount of force applied to a viscous liquid, to get it to flow, inherently involves some level of shear occurring in the viscous liquid. The injection process should, however, be performed in a manner which holds the amount of shear in the cheese to that level which is consistent with maintaining the cheese texture while still accomplishing an effective and efficient movement of the cheese into receptacle mold 102.

To that end, nozzle 72 has an effective diameter of about 0.19 inch to about 0.50 inch at the smallest cross-section of the nozzle, with at least 0.25 inch being preferred in order to facilitate fill speed while maintaining excellent texture in the resultant fabricated cheese product. Any feed line, not shown, leading to nozzle 72 and carrying the cheese product desirably has at least as great a cross-section as the smallest cross-section of the nozzle, and optionally a cross-section greater than the least cross-section of the nozzle.

Further to the end of not deleteriously affecting the texture of the cheese, the temperature of the cheese is pre-conditioned to that temperature which is desirable for efficient flow of the cheese while not overly affecting the texture of the cheese. The rate of flow of the cheese, and the length of the path of constricted flow of the cheese from e.g. a cheese receptacle, is controlled such that the temperature of the cheese does not rise much, if any, between the cheese receptacle and the outlet end of the nozzle. While any amount of flow of the cheese inherently incurs some heat generation from the shear affect of the flow, a temperature rise of no more than about 2 degrees F. to about 5 degrees F. is desirable so as to maintain maximum texture value in the resultant cheese.

So long as the temperature of the cheese is maintained at a temperature which accommodates viscous flow of the cheese, the injection process can readily be used to fill a receptacle mold such as the illustrated mold 102 whereupon the cheese will, of its own accord, and over time of a few minutes to a few hours, settle upon itself, filling in the voids within the body of the cheese as well as filling in the spaces between the cheese and the inner surface of the mold. The container is filled and is optionally sealed under vacuum conditions. Gravitational forces on the cheese perform a substantial portion of the settling and void filling actions. The cheese is optionally maintained within about 5 degrees F. of the filling temperature throughout the settling period, which enhances the ability of the cheese to settle promptly. Pulling a modest vacuum during some or all of such settling period enhances the speed of the consolidation of the cheese in the mold.

A sealing closure is applied as necessary to the mold, either closing the existing mold elements about themselves, or by adding a closure element to the package to fully close and seal the package. Further, the temperature is typically lowered to whatever temperature is preferred for extended storage of that particular variety of cheese, such as 44 degrees F. for cheddar cheese.

As with all cheese products useful in the invention, whether formed by injection or by pressure molding, such cooling tends to harden the contained cheese product. The harder the cheese product the greater the tendency for the cheese to retain the molded shape and size when removed from the mold. Accordingly, even though the cheese is viscously flowable during fabrication of the shape and size of the cheese product, after cooling, the cheese typically is substantially harder whereby the temperature change is quite effective in ensuring that the cheese maintains the reconfigured new size and shape.

As indicated above, the methods and products described herein can be employed on a wide variety of cheese products. Where the cheese product is sticky, such as cream cheese, a thin release sheet liner can be employed to assist in release of the molded cheese product. The release liner is placed against the inner surfaces of the finishing mold elements, about a substantial fraction of the overall area of the inner surfaces of the finishing mold elements, optionally all of the inner surfaces of any cavity 60 or backing sheet or plunger 58 or other cover which may be placed over a cavity 60 as a second finishing mold element. Exemplary suitable such liners can be made from 0.0005 inch thick polyethylene, available as GLAD® Cling Wrap, from Glad Products Corporation, Oakland, Calif.

Wax coating can be used as the outer packaging material of choice. In such instance, cheese is formed as described herein, then removed from the mold and coated with wax. The wax provides an oxygen barrier for preservation of the cheese.

As used herein, a “lofted” portion of a product is any portion which extends away from a conventional “X”, “Y”, or “Z” plane.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A cheese product comprising a mass of cheese having a plurality of outer surface elements which collectively define an outer surface of said cheese product, said cheese product having a length and a width, the length being greater than the width, first and second ends defined by converging ones of the outer surface elements, and a longitudinal axis extending between the first and second ends, said cheese product being substantially free from any substantially flat ones of the outer surface elements of said cheese product, proximate either of the first and second ends and extending across the longitudinal axis.

2. A cheese product as in claim 1 wherein one or more flat ones of the outer surface elements collectively represent from zero up to no more than about 5 percent of the outer surface of said cheese product.

3. A cheese product as in claim 1, said cheese product further comprising a relatively greater-diameter medial portion, and first and second tapered end portions terminating in the first and second ends.

4. A cheese product as in claim 3, said cheese product further comprising a relatively planar surface generally aligned with the longitudinal axis and being disposed in the medial portion.

5. A cheese product as in claim 4, the length being generally aligned with the longitudinal axis, the relatively planar surface having a second length, substantially shorter than the first length.

6. A cheese product as in claim 1, said cheese product comprising a main body, and further comprising one or more relatively thin outer layers of cheese overlying the outer surface of said main body, and collectively covering no more than about 20 percent of said main body.

7. A cheese product as in claim 1, said cheese product comprising a main body, and further comprising one or more relatively thin outer layers of a meat product overlying the outer surface of said main body, and collectively covering no more than about 20 percent of said main body.

8. A cheese product as in claim 1, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

9. A cheese product as in claim 8, one of said finishing mold elements comprising a plunger which extends into another of said finishing mold elements.

10. A cheese product as in claim 8, further comprising a bag, overlying said finishing mold elements, and providing an outer enclosing structure of said package.

11. A cheese product having a generally non-globoidal shape and comprising a mass of cheese, and an outer surface of said cheese product, said cheese product being substantially free from any flat element of the outer surface which defines more than about 5 percent of the outer surface.

12. A cheese product as in claim 11, said cheese product further comprising a relatively greater-diameter medial portion, and first and second tapered end portions terminating in the first and second ends.

13. A cheese product as in claim 1 1, said cheese product being substantially free from flat elements of the outer surface which collectively define more than about 5 percent of the outer surface.

14. A cheese product as in claim 11, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

15. A cheese product as in claim 14, one of said finishing mold elements comprising a plunger which extends into another of said finishing mold elements.

16. A cheese product as in claim 14, further comprising a bag, overlying said finishing mold elements, and providing an outer enclosing structure of said package.

17. A cheese product comprising a mass of cheese having a plurality of separately visually distinguishable outer surface elements which collectively define an outer surface of said cheese product, one or more of the outer surface elements which define at least 5 percent of the collective outer surface and being substantially lofted, or being substantially concave and non-spherical in primary outline.

18. A cheese product as in claim 17 wherein one or more flat ones of the outer surface elements collectively represent from zero up to no more than about 5 percent of the outer surface of said cheese product.

19. A cheese product as in claim 17, said cheese product further comprising a relatively greater-diameter medial portion, and first and second tapered end portions terminating in the first and second ends.

20. A cheese product as in claim 17, said cheese product further comprising first and second ends, and a longitudinal axis extending between the first and second ends, and a generally planar surface generally aligned with the longitudinal axis.

21. A cheese product as in claim 20, further comprising a first length between the first and second ends, and generally aligned with the longitudinal axis, the relatively planar surface having a second length, substantially shorter than the first length.

22. A cheese product as in claim 17, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

23. A cheese product as in claim 22, one of said finishing mold elements comprising a plunger which extends into another of said finishing mold elements.

24. A cheese product as in claim 22, further comprising a bag, overlying said finishing mold elements, and providing an outer enclosing structure of said package.

25. A cheese product comprising a mass of cheese having one or more outer surface elements which collectively define an outer surface of said cheese product, at least 50 percent of the outer surface of said cheese product being defined by one or more non-globoidal substantially lofted and/or non-globoidal substantially depressed portions of the outer surface, and wherein such substantial loftings and/or substantial depressions in such lofted and/or depressed portions represent at least about 25 percent of the lofted and/or depressed portions.

26. A cheese product as in claim 25, said cheese product being substantially free from any flat surface element which defines more than about 5 percent of the outer surface.

27. A cheese product as in claim 25, said cheese product further comprising a relatively greater-diameter medial portion, and first and second tapered end portions terminating in first and second ends.

28. A cheese product as in claim 25, said cheese product further comprising first and second ends, and a longitudinal axis extending between the first and second ends, and a generally planar surface generally aligned with the longitudinal axis.

29. A cheese product as in claim 28, further comprising a first length between the first and second ends, and generally aligned with the longitudinal axis, the relatively planar surface having a second length, substantially shorter than the first length.

30. A cheese product as in claim 25, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

31. A cheese product as in claim 30, one of said finishing mold elements comprising a plunger which extends into another of said finishing mold elements.

32. A cheese product as in claim 30, further comprising a bag, overlying said finishing mold elements, and providing an outer enclosing structure of said package.

33. A cheese product comprising a mass of cheese having a plurality of outer surface features which collectively define an outer surface of said cheese product, one or more of the outer surface features being characterized by one or more of lofted portions which are non-globoidal in primary outline, and/or one or more of concave portions which are non-spherical in primary outline.

34. A cheese product as in claim 33, said cheese product having first and second ends, and wherein a plurality of the lofted and/or concave portions extend along the length of the cheese product.

35. A cheese product as in claim 33, said cheese product having first and second ends, a plurality of the lofted and/or concave portions extending along the length of the cheese product and having length to width ratios of at least about 5 to 1.

36. A cheese product as in claim 33, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

37. A cheese product as in claim 36, one of said finishing mold elements comprising a plunger which extends into another of said finishing mold elements.

38. A cheese product as in claim 36, further comprising a bag, overlying said finishing mold elements, and providing an outer enclosing structure of said package.

39. A cheese product comprising a mass of cheese having a plurality of outer surface features which collectively define an outer surface of said cheese product, said cheese product comprising a main body, and one or more of the outer surface features comprising an appendage extending from said main body.

40. A cheese product as in claim 39, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

41. A cheese product as in claim 40, one of said finishing mold elements comprising a plunger which extends into another of said finishing mold elements.

42. A cheese product as in claim 40, further comprising a bag, overlying said finishing mold elements, and providing an outer enclosing structure of said package.

43. A cheese product as in claim 39, said main body comprising a first major body, and further comprising a second major body, connected to said first major body by said appendage, whereby said appendage comprises an isthmus between said first and second main bodies, said isthmus having “X” and “Y” dimensions, transverse to an imaginary line extending through said isthmus and into said first and second major bodies, less than corresponding “X” and “Y” dimensions of said first and second major bodies as measured from the same imaginary line.

44. A cheese product comprising a mass of cheese, and an outer surface of said cheese product, the outer surface having a plurality of separately distinguishable surface variation elements disposed about more than a 180 degree portion of the outer surface, the surface variation elements comprising lofted projections visible with a naked eye in primary outline, and/or substantially concave elements visible with the naked eye and which are non-spherical in primary outline.

45. A cheese product as in claim 44 wherein the surface variation elements collectively extend substantially about said cheese product.

46. A cheese product as in claim 44 wherein the surface variation elements collectively extend substantially about said cheese product, and wherein the portion of the surface area of the cheese product which is covered by surface variation elements and spaces between closely adjacent ones of the surface variation elements represents at least 50 percent of the entirety of the surface area of said cheese product.

47. A cheese product as in claim 44, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

48. A cheese product as in claim 47, one of said finishing mold elements comprising a plunger which extends into another of said finishing mold elements.

49. A cheese product as in claim 47, further comprising a bag, overlying said finishing mold elements, and providing an outer enclosing structure of said package.

50. A cheese product comprising a mass of cheese, and comprising:
(a) a first inner mass of a first food product defined in terms of first visual or tactile or taste sensibility; and
(b) a second outer mass of a second food product, disposed outwardly of said first inner mass of said first food product, said second food product being defined in terms of second visual or tactile or taste sensibility, substantially different from at least one of the first visual or tactile or taste sensibility of said first food product, and wherein at least one of said first and second food products is a cheese product.

51. A cheese product as in claim 50 wherein said second outer mass of said second food product comprises a cheese product and entirely encompasses said first inner mass of said first food product.

52. A cheese product as in claim 50 wherein said first food product comprises a first cheese and wherein said second food product comprises a second cheese, and wherein said first cheese differs from said second cheese in taste.

53. A cheese product as in claim 50 wherein said first food product comprises a first cheese and wherein said second food product comprises a second cheese, and wherein said second outer mass of said second cheese differs from said first cheese in visual sensibility.

54. A cheese product as in claim 50 wherein said first food product comprises a first cheese and wherein said second food product comprises a second cheese, wherein said second cheese differs from said first cheese according to color.

55. A cheese product as in claim 50 wherein said first food product comprises a first cheese and wherein said second food product comprises a second cheese, wherein said second cheese differs from said first cheese according to texture.

56. A cheese product as in claim 50, said cheese product being contained in a package, defined by packaging structure, said packaging structure comprising one or more finishing mold elements effective to fabricate said cheese product into a finished shape and size upon evacuation of air from said package and application of ambient air pressure to an outside surface of said package.

57. A cheese product as in claim 56, one of said finishing mold elements comprising a plunger which extends into another of said finishing mold elements.

58. A cheese product as in claim 56, further comprising a bag, overlying said finishing mold elements, and providing an outer enclosing structure of said package.

59. A method of making a cheese product into a desired finished shape and size after forming cheese curd, the method comprising:
(a) providing a portion of such cheese curd, or a subsequently developed product derived from such cheese curd, in working relationship with one or more pre-form molds, which pre-form molds generally reflect the desired finished shape and size of the desired cheese product in gross outline;
(b) applying pressure to the molds, and through the molds to the block of cheese while the block of cheese is at a temperature substantially below the melting temperature of the cheese, thereby to cold-form the cheese into a cheese pre-form which generally reflects the desired finished shape and size of the cheese product, and which contains a mass of cheese closely corresponding to the desired finished shape and size of the cheese product;
(c) placing the cheese pre-form in molding relationship to at least first and second finishing mold elements which collectively have an interior surface which closely reflects the desired finished shape and size of the cheese product, the finishing mold elements defining packaging material;
(d) closing off the combination of the cheese pre-form and the finishing mold elements from ambient air pressure, and while so closed off, evacuating air from the combination of the cheese pre-form and the mold elements, and using the finishing mold elements as at least part of a packaging structure to separate the cheese pre-form from ambient air, and sealing the packaging structure thereby to provide a closed and sealed package;
(e) subjecting an outer surface of the package to gaseous pressure which causes the packaging material to exert pressure on the contained cheese pre-form, sufficient to cause the cheese in the pre-form to flow, relative to the finishing mold elements, and along and into respective contours at the inner surfaces of the mold elements, whereby the finished shape of the so-formed cheese product closely reflects the interior surfaces of the finishing mold elements while the interior surfaces of the mold elements substantially retain their shapes.

60. A method as in claim 59, further comprising holding the cheese product in the closed and sealed package for a time necessary for the cheese product to substantially fully conform to the finishing mold elements, and to dissipate substantially all of any spring-back forces.

61. A method as in claim 59, further comprising holding the cheese product in the closed and sealed package for a time necessary for the cheese product to substantially fully re-knit together in the newly-established shape of the cheese product.

62. A method as in claim 59, further comprising providing a release sheet between the cheese and the finishing mold elements.

63. A method as in claim 59, further comprising pre-warming the cheese to a temperature no less than 30 degrees F. below the melting point of the cheese before forming the cheese pre-form.

64. A method as in claim 59, further comprising shipping the so-packaged cheese product into commerce while the cheese product is contained in a package comprising the finishing mold elements.

65. A method as in claim 59 wherein material for the finishing mold elements is selected from the group consisting of polyethylenes, polypropylenes, polyethylene terephthalates, polyvinyl chlorides, and polyamides.

66. A method as in claim 59, further comprising, prior to subjecting the outer surface of the package to the gaseous pressure, overwrapping the combination of the cheese pre-form and the finishing mold elements in a bag, and subsequently performing the evacuating of air from the combination, and sealing the packaging structure, the sealing of the packaging structure comprising at least in part forming closure seal to thereby seal the bag.

67. A method as in claim 59 wherein the portion of cheese curd or a subsequently developed product derived from such cheese curd comprises a consolidated block of cheese.

68. A method as in claim 67 wherein the cheese is a ripened cheese.

69. A method of making a cheese product into a desired finished shape and size after forming cheese curd into chunks of cheese, the method comprising:
(a) comminuting the cheese thereby to form a mass of comminuted cheese particles;
(b) providing a portion of the mass of comminuted cheese in molding relationship to at least first and second finishing mold elements which collectively have an interior surface which closely reflects the desired finished shape and size of the cheese product, the finishing mold elements defining packaging material;
(c) closing off the combination of the portion of the mass of comminuted cheese, and the finishing mold elements, from ambient air pressure, and while so closed off, evacuating air from the combination of the cheese and the mold elements, and using the mold elements as at least part of a packaging structure to separate the cheese from ambient air, and sealing the packaging structure thereby to provide a closed and sealed package; and
(d) subjecting an outer surface of the package to gaseous pressure which causes the packaging material to exert pressure on the contained cheese, sufficient to cause the cheese to flow, relative to the finishing mold elements, and along and into respective contours at the inner surfaces of the mold elements, whereby the finished shape of the so-formed cheese product closely reflects the interior surfaces of the finishing mold elements while the interior surfaces of the mold elements substantially retain their shapes.

70. A method as in claim 69, further comprising holding the cheese product in the closed and sealed package for a time necessary for the cheese product to substantially fully conform to the finishing mold elements, and to dissipate substantially all of any spring-back forces.

71. A method as in claim 69, further comprising holding the cheese product in the closed and sealed package for a time necessary for the cheese product to substantially fully re-knit together in the newly-established shape of the cheese product.

72. A method as in claim 69, further comprising providing a release sheet between the cheese and the finishing mold elements.

73. A method as in claim 69, further comprising shipping the so-packaged cheese product into commerce while the cheese product is contained in a package comprising the finishing mold elements.

74. A method as in claim 69 wherein material for the finishing mold elements is selected from the group consisting of polyethylenes, polypropylenes, polyethylene terephthalates, polyvinyl chlorides, and polyamides.

75. A method as in claim 69, further comprising, prior to placing the cheese in molding relationship to the at least first and second finishing mold elements, providing the mass of cheese particles in working relationship with one or more pre-form molds, which generally reflect the desired finished shape, and which are over-sized with respect to the desired cheese product, in gross outline, and applying differential pressure to the pre-form molds, and through the pre-form molds to the cheese particles at a temperature substantially below the melting temperature of the cheese, thereby to cold-form the cheese into a relatively higher density cheese pre-form which generally reflects the desired finished shape of the cheese product, and which contains a quantity of cheese closely corresponding to the quantity necessary to fabricate a cheese product of the desired finished shape and size, wherein the placing of the cheese in molding relationship to the at least first and second finishing mold elements comprising placing the cheese pre-form in molding relationship to the at least first and second finishing mold elements.

76. A method as in claim 69, further comprising, prior to subjecting the outer surface of the package to the gaseous pressure, overwrapping the combination of the cheese and the finishing mold elements in a bag, and subsequently performing the evacuating of air from the combination and the sealing of the packaging structure, the sealing of the packaging structure comprising at least in part forming a closure seal to thereby seal the bag.

77. A method as in claim 69 wherein the portion of cheese curd or a subsequently developed product derived from such cheese curd comprises a consolidated block of cheese.

78. A method as in claim 77 wherein the cheese is a ripened cheese.

79. A method of making a cheese product into a desired finished shape and size of up to about 3 ounces, after forming cheese curd into chunks of cheese, the cheese product having an outer surface, the method comprising:
(a) comminuting the cheese thereby to form a mass of cheese particles;
(b) providing a portion of the mass of the cheese particles, generally reflecting the desired mass of the finished cheese product, in working relationship overlying a cavity in a finishing mold, which reflects the desired finished shape of a substantial portion of the outer surface of the cheese product;
(c) providing a cover over the portion of the mass of cheese particles and generally overlying both the cheese particles and the cavity in the finishing mold, with the cheese between the cover and the cavity;
(d) collectively closing off the combination of the finishing mold, the cheese particles, and the cover, from ambient air, and evacuating air from the collective combination, and applying sealing closure about the combination of the finishing mold, the cheese particles, and the cover, thereby to provide a closed package; and
(e) applying differential pressure to the mold and the cover, and through the mold and cover to the cheese particles, while the cheese particles are at a temperature substantially below the melting temperature of the cheese, thereby to cold-form the cheese particles into the cavity in the finishing mold such that the cheese particles re-knit to each other and flow to conform to the inner surface of the finishing mold, with the cover optionally flexing toward the cavity of the finishing mold, thereby to encourage movement of the cheese particles into the cavity whereby the finished shape of the so-formed cheese product closely reflects the interior surfaces of the finishing mold elements while the interior surfaces of the mold elements substantially retain their shapes.

80. A method as in claim 79, further comprising holding the cheese product in the closed and sealed package for a time necessary for the cheese product to substantially fully conform to the finishing mold element, and to dissipate substantially all of any spring-back forces.

81. A method as in claim 79, further comprising holding the cheese product in the closed and sealed package for a time necessary for the cheese product to substantially fully re-knit together in the newly-established shape of the cheese product.

82. A method as in claim 79, further comprising providing a release sheet between the cheese and the finishing mold element.

83. A method as in claim 79, further comprising shipping the so-packaged cheese product into commerce while the cheese product is contained in a package comprising the finishing mold element.

84. A method as in claim 79 wherein material for the finishing mold elements is selected from the group consisting of polyethylene, polypropylenes, polyethylene terephthalates, polyvinyl chlorides, and polyamides.

85. A method as in claim 79, further comprising, prior to subjecting the outer surface of the package to the gaseous pressure, overwrapping the combination of the cheese pre-form and the finishing mold elements in a bag, and subsequently performing the evacuating of air from the combination and the sealing the packaging structure, the sealing of the packaging structure comprising at least in part forming closure seal to thereby seal the bag.

86. A method as in claim 79 wherein the cheese is a ripened cheese.

87. A method as in claim 79 wherein the cover comprises a backing sheet.

88. A method as in claim 79 wherein the cover is comprised in a bag.

89. A method as in claim 79 wherein the cover comprises a plunger.

90. A method of providing a cheese product, comprising cheese which has reached at least the stage of development of curd, the cheese product having a relatively stable desired finished shape and size at a temperature normal for storage of the cheese after the cheese product is made, the method comprising:
(a) providing a packaging receptacle, as a packaging material, adapted and configured to receive such cheese thereinto;
(b) injecting into the packaging receptacle, through an orifice having an open area corresponding to a diameter of about 0.19 inch to about 0.50 inch, a flow of the cheese, in a warm condition substantially below a melting temperature of the cheese, such that the cheese is readily flowable but not liquid;
(c) facilitating release of air from the packaging receptacle consistent with the injection of the cheese into the receptacle;
(d) providing a closed and sealed packaged cheese product, containing the cheese, by providing a closing and sealing packaging closure closing the receptacle, and effecting closure thereof; and
(e) holding the packaged cheese product in such package for a time sufficient to substantially fully conform the cheese product to the receptacle and/or to substantially congeal together the cheese product in the desired finished shape and size.

91. A method as in claim 90, further comprising removing the cheese product from the packaging materials, whereupon a such cheese product, when at the normal storage temperature for the cheese when removed from the packaging materials, effectively retains substantially the same size and shape as when packaged, for at least 30 minutes in an environment wherein air temperature is 73 degrees F.
